(19) United States
(12) Patent Application Publication
(10) Pub. No.: US 2026/0249297 A1
(43) Pub. Date: Aug. 27, 2026

(54) ELUTION KIT, ANALYTICAL KIT AND METHOD OF ELUTING AND ANALYZING A BIOLOGICAL SAMPLE

(71) Applicant: Roche Diagnostics Operations, Inc., Indianapolis, IN (US)

(72) Inventors: Martin Blum, Mannheim (DE); Yilmaz Isgoeren, Mannheim (DE); Sascha Meyer Dos Santos, Mannheim (DE)

(21) Appl. No.: 19/643,526

(22) Filed: Apr. 9, 2026

Related U.S. Application Data
(63) Continuation of application No. PCT/EP2024/078090, filed on Oct. 7, 2024.

(30) Foreign Application Priority Data
Oct. 10, 2023 (EP) 23 202 666.6

(51) Int. Cl. B01L 3/00

(52) U.S. Cl. CPC B01L 3/5029; B01L 3/5023; B01L 2200/026; B01L 2200/0689; B01L 2200/087; B01L 2200/10; B01L 2300/0825; B01L 2300/0832; B01L 2300/126; B01L 2400/0644; B01L 2400/0677

(57) ABSTRACT

An elution kit for eluting and then dispensing a biological sample onto a test element of an analytical kit. The kit has a sample collection swab that has a stick portion for holding and a deformable head portion that is porous for the liquid. An elution liquid tube has an interior space with an insertion opening on a first side and a dispense opening on a second side. A first closure element seals the dispense opening and a second closure element seals the insertion opening. One or both of the first and second closure elements has a foil. The interior space has an elution portion that has a smallest side-to-side distance y between 70% and 140% of a largest side-to-side distance x of the head portion of the collection swab and defines a gap through which the swab can be pushed and pulled when the dispense opening is closed. 5234968

### RELATED APPLICATIONS

This application is a continuation of PCT/EP2024/078090, filed Oct. 7, 2024, which claims priority to EP 23 202 666.6, filed Oct. 10, 2023, the entire disclosures of both of which are hereby incorporated herein by reference.

### BACKGROUND

This disclosure relates to an elution kit, an analytical kit comprising the elution kit and a method of eluting and analyzing a biological sample based on the analytical kit in the field of In Vitro Diagnostics (IVD).

The elution of a biological sample in a liquid has been widely practiced during the Covid 19 pandemic when users performed self-testing using lateral flow assays. Test kits which were used in terms of the self-testing typically comprise a swab for collecting a biological sample, a vial containing a liquid, in which the biological sample can be eluted and a lateral flow assay that comprises a test element such as a test strip onto which the liquid with the eluted sample is applied and from which a test result can be obtained. The test result provides information whether or not an analyte is present in the sample, such as the Covid 19 virus. The sensitivity and reliability of the test result is strongly dependent from the proper handling of the test kit and the correct execution of the sample elution. Typically, the test kits comprise a brief manual for the user to guide him/her through the procedure of performing the test. However, in most cases, the test kits leave a certain degree of freedom to the user such that every user may vary the performance of the test, which may lead to a poor reliability and reproducibility of the test and potentially to false negative test results. Therefore, most test kits, which require the elution of a biological sample executed by a private user, cannot guarantee a high degree in reliability and reproducibility due to potential deviations from the procedure described in the manual by the users. In more detail, a typical procedure of eluting the sample in the liquid comprises immersing the head of the swab in a liquid provided in the vial, such that the collected sample can be eluted therein. The swab is inserted into and rotated inside the vial, wherein at the same time the vial is manually squeezed to provide a certain degree of friction having the effect of eluting the collected sample in the liquid. Once the swab has been rotated a predetermined number of times while squeezing the vial, the swab is withdrawn and the vial is closed with a cap. Often, the cap has an application function that allows dosage of the liquid dropwise onto the test element. Therefore, the closed vial is flipped with its cap pointing downwards and the vial is squeezed until the droplets are pressed out of the vial through a small opening in the cap of the vial, which may correspond to the application function. This procedure is relatively simple—but may, however, be improved in terms of repeatability, reliability and user-friendliness.

### SUMMARY

It is therefore desirable to provide a more reliable elution kit, an analytical kit comprising the elution kit and a method of eluting and analyzing a biological sample based on the analytical kit. It is further desirable to provide an elution kit that is easy, comfortable and/or reliable to handle by a user.

According to an aspect, which may be considered the first aspect of the present disclosure, an elution kit for eluting a biological sample in a liquid and dispensing the eluted sample liquid onto a test element of an analytical kit, the elution kit comprises: a sample collection swab for collecting the biological sample, wherein the sample collection swab comprises a stick portion for being hand-held and a deformable head portion on the stick portion for collecting the biological sample, wherein the head portion is porous for the liquid; and an elution liquid tube which comprises: an interior space for housing the liquid, receiving the sample collection swab and eluting the biological sample in the liquid; an insertion opening on a first side of the interior space for inserting the sample collection swab into the interior space; a dispense opening on a second side of the interior space adjacent the first side for dispensing the eluted sample liquid; a first closure element to seal the dispense opening in a water-vapor impermeable manner; a second closure element to seal the insertion opening in a water-vapor impermeable manner, wherein the first closure element and/or the second closure element comprises a foil; and the liquid, wherein the elution liquid tube contains the liquid, wherein the interior space is defined by an inner surface that comprises an elution zone with at least one elution portion having a smallest side-to-side distance y ranging between approximately 70% and 140% of a largest side-to-side distance x of the head portion of the sample collection swab and defining a gap through which the sample collection swab can be pushed and pulled in a closed state of the dispense opening.

The elution kit is simple to be used and configured for easy handling. The liquid is already provided inside the elution liquid tube, which avoids the risk of spilling and/or losing liquid if a user would transfer the liquid into the elution liquid tube. Further, this allows the user to perform this step himself, which makes it comfortable to use the elution kit. The sealing closure elements, of which at least one comprises a foil, are required to confine the liquid inside the elution liquid tube and to prevent leakage of the liquid in the liquid and/or vapor form before the elution kit is used. Further, the closure elements prevent the liquid from being contaminated before removal of one or both closure elements. It is simple and cheap to provide a foil on an opening and it may be easily and reliably removed by a user. This is specifically useful when the elution kit is meant for single use. The foil reliably seals the opening in a water vapor impermeable manner.

As the interior space of the elution liquid tube is limited due to the side-to-side distance y that ranges around the size of the sample collection swab, an air-filled dead space/volume is reduced such that small amounts of liquids can be enclosed inside the elution liquid tube without the risk of substantial amounts thereof evaporating into the air-filled dead space/volume.

The inner surface of the elution liquid tube may be considered the inner tube wall(s) of the elution liquid tube or a portion thereof. When pushing the sample collection swab through the at least one elution portion into the liquid in a closed state of the dispense opening, the liquid is pressed and/or displaced upwards through the pores of the head portion and/or through the space between the inner sidewall of the elution zone (specifically between the elution portion) and the head portion. Some of the liquid remains in the pores of the head portion. A substantial amount of the provided liquid may be mixed and may pass through or pass by the head portion, on which the biological sample sticks. High shear forces can be generated by moving the sample collection swab through the at least one elution portion to efficiently transfer the biological sample into the liquid by a physical impact. Therefore, the sample may be eluted effectively, reliably and with reproducible results without the user being required to squeeze a tube as it is usually done when eluting a sample on a swab in a solution and which bears the risk of human errors and low effectivity.

A reliable water-proof/water-vapor-proof seal can be realized in an easy way requiring a low amount of material by using a foil that covers an opening. Moreover, a foil is easily removed by a user. This may specifically be advantageous in single-use elements where an opening is not required to be opened and closed multiple times but only once when being used. This allows providing a cheap elution kit, specifically for single-use which is based on a simple concept. At the same time, the elution kit can be produced at low cost and low material consumption and produces less waste compared to concepts in which caps or other more complex closure elements are used to seal an opening. Therefore, an improved elution kit may be provided.

The interior space of the elution liquid tube, which has a substantially tube-like shape comprises two openings which are sealed by a first and a second closure elements, respectively, to confine the liquid inside the elution liquid tube and to prevent loss of liquid via diffusion and/or leakage. Therefore, the first and a second closure elements are specifically water-and water-vapor impermeable and are coupled or configured to be coupled to the elution liquid tube in a way that prevents loss of liquid via diffusion and/or leakage. Therefore, also the couplings between the first and a second closure elements and the elution liquid tube are water-and water-vapor impermeable. One opening is for inserting the sample collection swab and the other one opening is for dispensing the sample liquid. The insertion opening on the first side of the interior space is hence configured for inserting the sample collection swab into the interior space and the dispense opening on the second side of the interior space adjacent the first side is configured for dispensing the eluted sample liquid. The second closure element to seal the insertion opening may be removed first such that the sample collection swab can be introduced into the elution liquid tube. Later, when the sample has been eluted in the liquid by inserting the sample collection swab, the first closure element to seal the dispense opening may be removed to dispense the eluted sample liquid. Therefore, the elution liquid tube is not required to be flipped/turned around and squeezed when the eluted sample liquid is applied onto a test element. The handling of the elution kit is therefore based on a different principle compared to the prior art systems. The eluted sample liquid is dispensed by moving the sample collection swab towards the opened dispense opening on the second side, such that the eluted sample liquid is pushed out of the interior space through the dispense opening in an opened state and applied onto a test element. The dosage may be manually well-controlled by the user via the movement and positioning of the sample collection swab. This allows a simple and convenient application without the need of turning/flipping around the elution liquid tube and dispensing the eluted sample liquid through the insertion opening. Hence, the reliable dosage and application of the sample liquid can be realized.

The sample collection swab has a porous and/or liquid-permeable head portion and can therefore be pushed and pulled through the interior space in a closed state of the dispense opening.

When properly used and when the elution liquid tube is held upright, the insertion opening corresponds to an upper opening and the first side corresponds to an upper side whereas the dispense opening corresponds to a lower opening and the second side corresponds to a lower side. In more detail, during the entire operation of eluting the sample and dispensing the eluted sample liquid, the insertion opening corresponds to an upper opening and the dispense opening corresponds to a lower opening.

The first side and the second side are arranged substantially opposite to each other. The insertion opening and the dispense opening may therefore also be arranged substantially opposite to each other, i.e., arranged on a common axis and adjacent to each other. In an alternative embodiment, in which the insertion opening and the dispense opening are not positioned on a common axis, at least one of the openings, most likely the dispense opening, may, without limitation, be arranged on a side of the elution liquid tube. In this case, the openings are not arranged on one common axis and the sample liquid is not dispensed and/or ejected along and/or through an opening on a common axis and/or an axis of the tube-like interior space, but towards a side, for example, at an angle of approximately 2°-45°, specifically around 5°-15° and more specifically around 6°-10°formed with the axis of the tube-like interior space. Nevertheless, in preferred embodiments, the tube-like interior space, the insertion opening and the dispense opening comprise one common longitudinal axis which is defined by their centers being aligned with each other. The sample collection swab can then be inserted along the common longitudinal axis (of the tube-like interior space, the insertion opening and the dispense opening) and therefore aligns with the common longitudinal axis. The stick portion of the sample collection swab has a longitudinal axis and the head portion is positioned on one end of the stick portion. The longitudinal axis may therefore, without limitation, align with and correspond to the common longitudinal axis (of the tube-like interior space, the insertion opening and the dispense opening) when being inserted into the tube-like interior space. The interior space may hence, without limitation, comprise and/or correspond to a channel-and/or a tube-like volume comprising a longitudinal axis along which the longitudinal axis of the stick portion of the swab may be moved (and/or parallel thereto). The step of receiving of the sample collection swab may hence, without limitation, correspond to a receiving of the sample collection swab by the interior space and by aligning the longitudinal axis of the sample collection swab with the longitudinal axis of the interior space.

The receiving of the sample collection swab by the interior space has the effect that the head portion is immersed in the liquid, wetted and hence the biological sample is at least partially eluted in the liquid. The liquid may, without limitation, correspond to or comprise an aqueous solution, specifically an aqueous buffer solution and/or another salt-containing aqueous solution. Alternatively or in addition, the liquid may comprise a solvent, which is not water-based.

The head portion may, without limitation, comprise or correspond to a sponge or a sponge-like element, tissue, cotton, fibers and/or the like. The head portion is deformable and may be soft, resilient, flexible and/or compressible. The head portion is porous for the liquid, which means that the liquid can flow through the pores and/or the empty spaces, which are defined by the structures and/or substructures of the head portion. For example, a sponge provides a substantially random sub-structure, which comprises a material with gas-filled spaces. The gas-filled spaces are considered as being the pores. The pores should not be fully (en)closed by the material and should therefore allow a fluid to enter and/or pass. This has the effect that, when the head portion is pushed down the tube of the interior space (having the same as or even a smaller diameter than the head portion) the liquid underneath the head portion may pass the head portion through its center and may also pass on its sides along the tube wall due to its porous structure. If the tube of the interior space has a smaller diameter than the head portion in a dry state (size of head portion is however determined in a dry state before being wetted), the head portion needs to be squeezed into the tube, which is possible as the head portion is deformable. The head portion may hence be considered compressible and/or flexible. In that case, the size, i.e., the largest side-to-side distance x of the head portion (which may be the diameter thereof) deforms and shrinks to the size and shape of the interior space in a cross section thereof.

The head portion may specifically, without limitation, have a porous sub-structure, which generates capillary forces, such as a fibrous and/or sponge-like structure. The fibrous and/or spongy material may therefore attract the liquid by means of van-der-Waals forces such that the gas-filled and/or air-filled spaces between the material portions fill with the liquid. The gas-filled spaces may hence, without limitation, be very small, namely in the range of microns to millimeters. In that range, capillary forces may be generated and specifically, aqueous solutions may be absorbed by the head portion. Further, specifically in the case, when the tube of the interior space has substantially the same or a smaller size than the head portion in a wetted state of the head portion, capillary forces may also be generated between the side wall of the elution liquid tube and the head portion. Depending on the content/compounds of the liquid, the head portion may comprise hydrophilic and/or hydrophobic materials. A hydrophilic material increases the attraction of aqueous solutions, which helps absorbing the liquid by the head portion. A hydrophobic material would have the opposite effect on an aqueous solution but might have the same effect on a non-polar solvent, for example. Therefore, as usually aqueous solutions are used for eluting a biological sample, it is preferred to provide a hydrophilic material constituting the head portion.

The elution liquid tube may, without limitation, be substantially stable in shape. Alternatively, the elution liquid tube may be slightly bendable. The stick portion of the sample collection swab may, without limitation, also be substantially stable in shape. Alternatively, the stick portion of the sample collection swab may be slightly bendable. In all cases, the elution liquid tube and the stick portion of the sample collection swab are substantially stable in shape when conventionally used according to their purpose. A slight bending of the stick portion may occur when the sample collection swab is inserted into a body opening like a nose, for example.

The biological sample may, without limitation, be collected from a body part, specifically an opening of a body, such as a nose.

The interior space of the elution liquid tube is defined, i.e., specifically surrounded by an inner surface that comprises an elution zone with at least one elution portion having a smallest side-to-side distance y ranging between approximately 70% and 140% of a largest side-to-side distance x of the head portion of the sample collection swab and defining a gap through which the sample collection swab can be pushed and pulled in a closed state of the dispense opening, i.e., when the dispense opening is closed.

The elution zone is a zone and/or region inside the interior space of the elution liquid tube in which the sample collection swab may come into contact with the sample liquid. This region may, without limitation, be substantially tube-like. The elution zone may, without limitation, have a smooth surface, i.e., a substantially smooth wall/walls (substantially unstructured) in that the inner surface of the elution zone is homogeneous, for example, corresponding to the inner surface of the tube without any irregularities. In that case, the entire elution zone may, without limitation, correspond to the elution portion which is defined by the above described ratio between its smallest side-to-side distance y and the largest side-to-side distance x of the head portion (smallest side-to-side distance y of elution portion ranging between approximately 70% and 140% of a largest side-to-side distance x of the head portion of the sample collection swab). Alternatively or in addition, the inner surface of the elution liquid tube in the elution zone may be structured and/or may have one or more elements corresponding to an elution portion. Specifically, the inner surface of the elution portion may comprise one or more elution portion. The structure and/or the elution portion may, without limitation, comprise a rib, a ribbed structure, a tapered structure and/or another structured surface of the inner surface of the interior space, as, for example, a honey comb structure or the surface structure thereof, a pinched structure, a nubby structure, a twisted structure/helix-like structure or the like.

The elution zone may refer, without limitation, to a substantially rigid portion of the elution liquid tube, which forms and/or defines a portion of the interior space of the elution liquid tube. The elution zone may therefore be substantially stable in shape. If the elution liquid tube is slightly bendable, as mentioned previously, the elution portion may be slightly bendable.

The largest side-to-side distance x of the head portion as mentioned herein without further note is defined in a (original) dry and relaxed state, i.e., a state in which the head portion is not wetted, deformed, squeezed and/or twisted. The largest side-to-side distance x in the dry state, also referred to “original state” may be defined easier, much better and/or more precisely than in the wet state and therefore, it is referred to the largest side-to-side distance x in the dry state. The largest side-to-side distance x of the head portion may change upon swelling and/or squeezing. Changes in this measure due to swelling and/or squeezing will be compared to the said original largest side-to-side distance x of the head portion defined in a dry and relaxed state. As already mentioned, when pushing the head portion of the sample collection swab into the liquid provided inside the elution liquid tube, the head portion can swell if allowed by the dimensions of the interior space of the elution liquid tube. The largest side-to-side distance x of the head portion of the sample collection swab is defined in the dry state and may correspond to a range of values for a certain number of swabs, for example, the range of values may, without limitation, allow a deviation of up to approx. +/−20%, specifically approx. +/−15% and more specifically approx. +/−5% of the average and/or predetermined value for the largest side-to-side distance x of the head portion. Swelling typically increases the original side-to-side distance x of the head portion since the air-filled spaces are filled with the liquid by a slightly larger volume than by air and squeezing decreases the original side-to-side distance x of the head portion such that the liquid is pressed out of the head portion. When referring to the “largest side-to-side distance x of the head portion” the original largest side-to-side distance x of the head portion in the dry and relaxed/non-compressed state is meant. The head portion of the sample collection swab may swell by approximately 0.2% to 20%, specifically by approximately 0.5% to 10% and more specifically by approximately 1% to 8%. Each head portion may have its own individual swelling behavior.

The external and/or mechanical forces which are otherwise typically applied by a user onto the head portion, can—according to this embodiment—be controlled and/or predetermined very well by means of an elution portion, which makes the elution process very reliable, effective and reproducible. If the smallest side-to-side distance y of the elution portion is smaller than the largest side-to-side distance x of the head portion, in the original and/or in the wet state, the head portion gets squeezed during insertion and the liquid which may be soaked by the head portion, may at least partially get wiped off and can mix with the other portion of the liquid. In other words, the head portion, such as a spongy head portion, may be squeezed and/or expressed by being pushed through the gap of an elution portion. Therefore, the specification of the elution zone and specifically of the elution portion may have several effects, namely the mixing of liquids and the squeezing and/or wiping off of the liquid inside and/or on the head portion. A manual, which may be provided to the user with the analytical kit may (pre)determine and/or recommend the number of times of pushing and/or pulling the sample collection swap through the elution zone and/or the elution portion. This allows a very reliable, reproducible and simple test being performed by a user. The elution liquid tube may in addition comprise at least one mark on the outside wall and/or the inside wall to provide as a visual indication for a position to which the head portion may be pushed and/or pulled and/or where the head portion may be rested.

The smallest side-to-side distance y of an elution portion may, for example, correspond to the diameter of the elution portion at its narrowest position, in a case when the elution portion has a ring-like shape and defines a substantially round gap/opening through the tube-like interior space. The gap/opening of the elution portion may be considered a constriction and/or narrowing with respect to other regions of the tube-like interior space and/or with respect to another region in the elution zone.

The common longitudinal axis of the tube-like interior space, the insertion opening and the dispense opening may be centered in the gap (e.g., round opening, without limitation) of the elution portion. Therefore, the longitudinal axis of the tube-like interior space, the insertion opening and the dispense opening may correspond to a common longitudinal axis with the gap of the elution portion. The gap of the elution portion may be homogeneous or tapered along the common longitudinal axis. If the gap is tapered, the smallest side-to-side distance y of the elution portion corresponds to the smallest diameter of the tapered gap. The tapered elution portion may extend from the inner wall of the tube-like interior space. A tapered elution portion may avoid sharp edges and therefore it may be avoided that the head portion is destroyed and/or ripped off. Further, a tapered elution portion may guide the head portion towards its predetermined position while the user only pushes and/or pulls the swap substantially along one single direction, for example, along the common axis. In other words, the user is not required to carefully position the swap perpendicularly to the common longitudinal direction, i.e., substantially the pushing and/or pulling direction.

The elution portion may, without limitation, define a gap/an opening of any possible shape, such as a round, polygonal, a square, an oval, a substantial star-like or a similar shape. The shape may, without limitation, be point symmetrical. In general, the elution portion may be tapered as mentioned before, specifically tapered along the longitudinal axis towards the dispense opening, which has the effect that the user cannot miss the opening when inserting and pushing the sample collection swab through the elution portion. Alternatively or in addition, the elution portion may be tapered along the longitudinal axis towards the insertion opening, which has the effect that the user cannot miss the opening when pulling the sample collection swab through the elution portion. In general and without limitation, edges, specifically sharp edges may be avoided.

An elution portion may alternatively and/or in addition act as a speed bumper for the sample collection swab. It may alternatively and/or in addition provide a haptic feedback to a user due to a higher mechanical resistance when pushing or pulling through and it may provide an information about where to stop the pushing and/or pulling. An elution portion may alternatively and/or in addition act as a retainer where the head portion may be rested and in that situation, the sample collection swab is not required to be held any longer by a user to prevent it from sliding down the interior space of the elution liquid tube.

The elution kit comprises: the first closure element to seal the interior volume of the elution liquid tube by covering the dispense opening; and/or the second closure element to seal the interior volume of the elution liquid tube by covering the insertion opening. In other words, the first closure element is configured to seal the dispense opening and the second closure element is configured to seal the insertion opening. The elution kit comprises the liquid, wherein the elution liquid tube contains the liquid and the first closure element and the second closure element confine the liquid together with the elution liquid tube inside the interior volume of the elution liquid tube in sealed, specifically a liquid-sealed, a liquid-vapor and/or a water-vapor-sealed manner.

The elution kit may comprise, without limitation: a first closure element to open and close the dispense opening; and/or a second closure element to open and close the insertion opening, wherein the closure elements are also configured for providing a sealed closure of the interior of the elution liquid tube.

The first closure element may comprise, without limitation, a plug, a cap, a foil and/or a film and may close, specifically seal the dispense opening, i.e., cover the dispense opening in a sealed manner. A foil and/or a film may be welded and/or laminated on the elution liquid tube over the dispense opening, for example, from below. A plug and/or a cap may be configured, without limitation, to repeatedly open and close the dispense opening whereas a foil and/or a film may be configured for closing and opening the dispense opening at least a single time.

The second closure element may comprise a plug, a cap, a foil and/or a film and may specifically seal the insertion opening, i.e., cover the insertion opening in a sealed manner. A foil and/or a film may be welded and/or laminated on the elution liquid tube over the insertion opening, for example, from above. A plug and/or a cap may be configured to repeatedly open and close the dispense opening whereas a foil and/or a film may be configured for closing and opening the dispense opening at least a single time.

An elution kit is provided with the elution liquid tube already containing the liquid. Therefore, the interior space is sealed by the first closure element and the second closure element to prevent leakage and/or diffusion of the liquid outside of the interior of the elution liquid tube. Further, the closure elements may prevent the interior space from being contaminated. If an elution liquid tube is not provided with the liquid being already filled therein, the elution liquid tube may be provided with the first closure element to seal the dispense opening once the liquid is filed into the elution liquid tube and with or without the second closure element.

The term “seal” refers to creating a watertight and in most cases an airtight closure to prevent any leakage or contamination. The term “seal” also refers to a closure that is water vapor-impermeable. This can be achieved through the use of gaskets, O-rings, or other sealing mechanisms to ensure a secure and reliable closure. For example, a cap as described herein may comprise an O-ring to seal the interior volume of a chamber. In addition, a heat-welded or welded or otherwise adhered foil, film, plate or membrane, which is water vapor-impermeable, may represent a seal.

The volume of the interior space of the elution liquid tube may be, without limitation, dimensioned to house a liquid volume of less than 1 ml, specifically less than 500 μl and more specifically less than 10 μl, and wherein the ratio “volume of the interior space” “liquid volume” may range below approximately 10; and/or the ratio “liquid volume” “liquid volume which is soaked in by the wetted head portion” may range between approximately 1 and 10.

The elution liquid tube may therefore, without limitation, be configured to house liquid volumes in small ranges, i.e., small amounts of a liquid and the head portion may be configured to soak the entire amount of the liquid of a portion thereof. An elution kit that allows handling small volumes of liquid has the effect that a sample can be eluted in a small volume such that a high ratio of “sample amount” “liquid volume” can be achieved. This may achieve that a test kit/analytical kit using this elution kit can provide a high degree in sensitivity as the sample is only slightly diluted and remains very concentrated. The interior space of the elution liquid tube may therefore, without limitation, have a small side-to-side distance and/or diameter as compared to the side-to-side distance and/or diameter defined by the outside walls of the elution liquid tube. This may allow to easily hold the elution liquid tube due to its outside circumference, while handling very small amounts of liquid stored inside the interior space.

The elution portion may comprise at least one of the following: at least one elution region with a length ranging between 10% and 98% of the length of the elution liquid tube measured along the (common) longitudinal axis of the insertion opening; at least one elution bulge with a length that corresponds to less than 10% of the length of the elution liquid tube measured along the (common) longitudinal axis of the insertion opening; and/or at least one helical thread-like bulge. An elution region differs from an elution bulge in the length measured along the (common) longitudinal axis of the insertion opening.

An elution region may correspond to a region in the elution zone, in which the inner tube diameter fulfills the requirement that a smallest side-to-side distance y ranges between approximately 70% and 140% of a largest side-to-side distance x of the head portion of the sample collection swab and defining a gap through which the sample collection swab can be pushed and pulled in a closed state of the dispense opening, i.e., when the dispense opening is closed. The elution region may have a length ranging between approximately 10% and 98% of the length of the elution liquid tube. The elution region may, without limitation, correspond to the entire elution zone in which the sample can be homogenously eluted, i.e., the pressure applied onto the head portion from the sides may be homogenous over the entire elution region. The elution region may, without limitation, range between approximately 50% and 100% of the length of the elution zone of the elution liquid tube.

An elution bulge with a length that corresponds to less than 10% of the length of the elution liquid tube and/or at least one helical thread-like bulge may, without limitation, have the specific effect of wiping off a soaked liquid from the head portion. Both of these variants of an elution portion may alternatively or in addition have the effect that the liquid may be mixed very well. Specifically, a helical thread-like bulge may on the one hand squeeze out the head portion very efficiently when pushing or pulling the head portion through and on the other hand the liquid may distribute very well by being guided along the helical ridges. An elution bulge may have a length that corresponds to less than 50% of the length of the elution liquid zone.

A gap, an opening and/or a through hole which is defined by the elution portion, the elution zone and/or any other zone or region in the elution liquid tube may, without limitation have a cross sectional shape comprising at least one of the following:
a round shape with a smallest side-to-side distance y, which corresponds to a diameter,
a polygonal shape, specifically a square shape,
an elliptic shape.

The elution liquid tube may comprise at and/or on the dispense opening and/or on the side of the dispense opening: a dispense nozzle defining the dispense opening; and/or a rim configured for setting down the elution liquid tube on a plane surface in an upright orientation. The rim may comprise an element of a coupling mechanism for coupling the elution liquid tube to a test element, optionally wherein the coupling mechanism comprises a thread mechanism, a bayonet and/or a Luer lock mechanism. Specifically in a case when no rim is provided, the elution liquid tube may comprise an element of a coupling mechanism for coupling the elution liquid tube to a test element, optionally wherein the coupling mechanism comprises a thread mechanism, a bayonet and/or a Luer lock mechanism. This element of a coupling mechanism may be positioned, for example, on the outer wall of the elution liquid tube.

A dispense nozzle defining the dispense opening may allow to precisely position the dispense opening and a droplet of the liquid ejected from the dispense opening on a test strip for example. A dispense nozzle may be, without limitation, aligned with the common longitudinal axis of the insertion opening, the tube-like interior space and the dispense opening. Alternatively, the dispense nozzle may be parallel to the (common) longitudinal axis of the insertion opening and/or the tube-like interior space but off center. The dispense nozzle may alternatively be slightly tilted with respect to the (common) longitudinal axis of the insertion opening and/or the tube-like interior. The dispense nozzle may, without limitation, be approximately 3-20 times, specifically around 5 -15 times and more specifically around 8-12 times shorter than the outer length of the elution liquid tube. The dispense nozzle may, without limitation, range between approximately 0.5 cm and 10 cm, specifically between approximately 1 cm and 8 cm, and more specifically between approximately 2 cm and 5 cm. The dispense nozzle may be permanently attached to the elution liquid tube or may be detachably coupled to the elution liquid tube, by means of a coupling and/or locking mechanism such as a Luer lock mechanism.

The rim may have the primary effect of allowing to set down the elution liquid tube in an upright orientation such that the elution liquid tube can be placed and stand on a table, for example. The rim may in some cases be provided in addition to the dispense nozzle. The rim may extend from the elution liquid tube in parallel to the dispense nozzle. Alternatively, the rim may extend from the elution liquid tube tilted with respect to the dispense nozzle (in a tapered manner for example) and/or the (common) longitudinal axis of the insertion opening and/or the tube-like interior space. Specifically, a permanently attached dispense nozzle may not exceed the rim along the (common) longitudinal axis of the insertion opening (on a lower end thereof) and/or the tube-like interior space. The rim may have the same length as the dispense nozzle specifically when the rim and the dispense nozzle extend in parallel to each other. The rim may, without limitation, be approximately 2-20 times, specifically around 4-15 times and more specifically around 6-12 times shorter than the outer length of the elution liquid tube. The rim may, without limitation, range between approximately 0.5 cm and 11 cm, specifically between approximately 1 cm and 10 cm, and more specifically between approximately 2 cm and 6 cm. The rim may be permanently attached to the elution liquid tube or may be detachably coupled to the elution liquid tube, by means of a coupling and/or locking mechanism.

The rim and/or the elution liquid tube may comprise an element of a coupling and/or locking mechanism for coupling the elution liquid tube to a test element. The coupling mechanism may comprise a thread mechanism, a bayonet and/or a Luer lock mechanism. One element of the coupling and/or locking mechanism may be provided on the inner and/or outer surface of the rim and the other element may be provided on the test element.

The elution liquid tube may comprise a filter which might be positioned in a lower portion of the elution liquid tube, for example, in front of or behind the dispense opening. The filter may be configured to filter out particles at a predetermined offset. In that case, only an eluted and filtered sample liquid which has substantially no particles or only particles below the predetermined offset may be ejected and/or dispensed.

The elution liquid tube may, without limitation, comprise at least one flexible, resilient and/or deformable member (like a lip and/or a flap) inside the elution zone, specifically a ring-shaped member with a central gap and/or opening, wherein the flexible member may be arranged perpendicularly to the common longitudinal axis or which may be tapered and/or tilted with respect to the common longitudinal axis. The effect of a flexible ring-shaped member in a lower region of the elution zone may be given in that the sample collection swap can be pulled through the gap of this member and liquid which is contained and/or soaked in the head portion may be wiped off of the head portion. The effect of such a member in a higher region of the elution zone may be given in that the liquid can be prevented from spilling out of the insertion opening when the sample collection swap is inserted. Further, such a flexible ring-shaped member may help to center the sample collection swab and align its longitudinal axis with the common longitudinal axis (of the insertion opening, the tube-like interior space and the dispense opening). Moreover, the flexible ring-shaped member may provide a certain degree of friction to stop and/or fix the position of the sample collection swap such that the sample collection swap does not slide down the tube-like interior space without applying a force. The flexible ring-shaped member may therefore act as a stopper. The flexible ring-shaped member may substantially correspond in the shape and the function to an elution portion however; the flexible ring-shaped member may provide a high degree in flexibility and can therefore be bent such that a liquid can be smoothly wiped off from the head portion. Further, due to its flexibility, the gap defined by the flexible ring-shaped member may be extended upon applying pressure with the head portion. In other words, the flexible ring-shaped member may be flexible and/or resilient which is typically not the case for the elution portion.

The interior space may comprise, without limitation: an insertion zone; the elution zone; and a dispense zone, optionally wherein, without limitation, the largest diameter of the interior space in the insertion zone is larger than the largest diameter of the interior space in the elution zone and/or the largest diameter of the interior space in the elution zone is larger than the largest diameter of the interior space in the dispense zone. Further, the smallest diameter of the interior space in the insertion zone may be larger than the smallest and/or largest diameter of the interior space in the elution zone and/or the smallest diameter of the interior space in the elution zone is larger than the smallest and/or largest diameter of the interior space in the dispense zone. If the shape of the corresponding gap is not round, the above features apply to a smallest or largest side-to-side distance instead of the diameter.

The largest or smallest diameter of the interior space in the insertion zone may, without limitation, be larger than the smallest or largest diameter of the interior space in the elution zone by approximately 1.2 to 10 times, specifically by approximately 2 to 8 times and more specifically by approximately 3 to 5 times. The largest or smallest diameter of the interior space in the elution zone may, without limitation, be larger than the smallest or largest diameter of the interior space in the dispense zone by approximately 1.5 to 20 times, specifically by approximately 2 to 10 times and more specifically by approximately 5 to 8 times. The diameter of the interior space in the insertion zone may, without limitation, range between approximately 0.8 cm and 3 cm, specifically between approximately 0.9 and 2.5 cm and more specifically between approximately 1 cm and 2 cm. The diameter of the interior space in the elution zone may, without limitation, range between approximately 0.2 cm and 1 cm, specifically between approximately 0.3 and 0.8 cm and more specifically between approximately 0.4 cm and 0.5 cm. The diameter of the interior space in the dispense zone may, without limitation, range between approximately 0.05 cm and 0.3 cm, specifically between approximately 0.08 and 0.2 cm and more specifically between approximately 0.1 cm and 0.15 cm.

In other words, the interior space of the elution liquid tube may be tapered from the insertion zone (where the sample collection swab is inserted) towards the dispense zone (where the eluted sample liquid is dispensed). This has the effect that the insertion of the sample collection swab is simple and uncomplicated for a user as the insertion zone is large enough to easily position the sample collection swab in the interior space of the elution liquid tube. The elution zone allows to contact the sample collection swab with minor amounts of liquid and the dispense zone does not trap substantial amounts of liquid and allow precise dosage of the liquid.

The outer diameter of the elution liquid tube may be around 3 or more times larger than the side-to-side distance y of the elution portion of the interior space in the elution zone, specifically around 8 or more times larger than the side-to-side distance y of the elution portion of the interior space in the elution zone, and more specifically around 20 or more times larger than the side-to-side distance y of the elution portion of the interior space in the elution zone.

This may allow handling very small amounts of liquid stored inside the interior space while easily grabbing and holding the elution liquid tube due to its outside circumference which is big enough to be easily hand-held.

According to another aspect, which may be considered the second aspect of the present disclosure, an analytical kit is provided for analyzing a biological sample comprising: the elution kit according to one of the embodiments described herein; and the test element comprising at least an application function, a test reaction function and a test detection function.

The analytical kit having an elution kit according to any one of the described embodiments herein allows a user to analyze a biological sample. Specifically, it may allow a user to detect a predetermined analyte, such at least one of the following and/or a fragment thereof: a virus, DNA, RNA, a hormone, bacteria and/or another biological molecule. All advantages and technical effects applying to the elution kit comprised by the analytical kit also apply to the analytical kit.

Specifically, in some embodiments, a more reliable analytical kit may be provided. Further, in some embodiments, an analytical kit can be provided that is easy, comfortable and/or reliable to handle by a user.

The test element may comprise a test element housing and/or an LFA-core strip (Lateral Flow Assay (core) strip).

In general, LFAs, such as LFA-strips or dip stick tests may be used in diagnostics applications. Test membranes which may be used in such tests may include, without limitation, silicone, plastic, glass, glass fiber, aluminum foil, paper, and/or other porous cellulose and rayon compounds being hydrophilic or hydrophobic. Specific lines may be applied to the membrane containing specific chemical capturing reagents or compounds, that are designed to react and bind with predetermined analytes, specifically biological markers which may be present in test sample liquids such as, but not limited to, sputum, urine, blood, water, liquefied food samples and surface swabbed samples. Specific examples of LFAs are rapid antigen tests for detecting the presence of analytes, such as virus fragments of infectious diseases in a biological sample. In general, LFA test units may be used in the form of test strips, such as, for example, pregnancy test strips, drug test strips, influenza and/or Covid 19 tests and/or allergen rapid tests.

When a sample liquid is applied onto an application region of an LFA test strip, the sample liquid is drawn by capillary forces along a longitudinal axis of the membrane (also called membrane analyte assay strip). The presence of predetermined analytes may be indicated when enzymes, target proteins and/or bio-markers corresponding to these analytes migrate along the membrane and interact with the chemical capturing reagents in the stripes of the membrane, thereby producing measurable and detectable signals/changes the analyte assay test zone(s). The resulting detectable and measurable signals at striped zones may, without limitation, be caused by binding with colloidal gold, charcoal beads, latex dyed beads, magnetic or paramagnetic beads and/or agents or particles capable of emitting fluorescence, auto-fluorescence, luminescence, phosphorescence, or chemiluminescence.

A test element housing is configured to house a test element at least partially. The test element housing may have a certain rigidity and/or stability configured to provide a protection for the test element. The test element housing may house some or all of the elements of the elution kit. The test element housing may specifically house at least partially the test element and the elution liquid tube. The test element housing may be substantially rigid in shape, i.e., not bendable. Alternatively, the housing may have a foldable, bendable and/or flexible envelope-like structure. Therefore, the housing may, for example, comprise, in some embodiments, a cardboard and/or plastic components. For example, the elution liquid tube may comprise a plastic tubing being fixed, attached and/or coupled to a cardboard element. The cardboard element may house and/or support the test element directly or indirectly. For example, the test element may be housed at least partially in a specific test element housing such as a plastic element and this plastic element may be housed and/or supported at least partially in or on the cardboard.

The test element may specifically comprise an LFA-core strip, which allows detecting molecular fragments and/or molecules of a predetermined analyte in a lateral flow assay.

The elution liquid tube of the elution kit and the test element may be arranged in a fixed relationship with each other, specifically being fixedly attached to each other and/or housed in a single unit and/or housing and/or formed as an integral unit; and/or wherein the analytical kit may comprise a fluid path being permanently provided between the elution liquid tube and the test element and comprising a fluid path closure element which is configured to stop the liquid from passing from the elution kit to the eluate application zone in a closed state of the fluid path and to allow the liquid to pass from the elution liquid tube to the eluate application zone in an opened state of the fluid path.

The term “being fixedly attached to each other” means that two or more elements are either formed as a single piece, for example, through injection molding or additive manufacturing, or that two or more elements are permanently attached with each other after being produced, for example, by heat-welding, adhesion, fusion or the like, and cannot be separated and/or moved against each other or with respect to each other at the connecting position without destroying at least one of the two or more elements and/or losing the actual full function of this element.

The elution liquid tube of the elution kit and the test element may be arranged in a fixed relationship with each other, which has the effect that a user is not required to arrange the elution liquid tube with respect to the test element. Further, the elution liquid tube or the test element does net get easily lost. The elution liquid tube of the elution kit and the test element may specifically be fixedly attached to each other, which may provide a permanent connection between them. The elution liquid tube of the elution kit and the test element may be positioned in, housed by, fixed and/or attached to one housing or two separate housings which are attached, coupled and/or fixed to each other, wherein the housing may in some cases correspond to the above described test element housing.

The elution liquid tube of the elution kit and the test element may be formed and/or housed in an integral unit and/or housed in one single housing, which may provide a permanent, substantially rigid and predefined connection between them. The housing may be formed from one single piece or may alternatively be composed of several pieces. A single piece housing which houses the elution liquid tube of the elution kit and/or the test element may be produced efficiently by means of injection molding or additive manufacturing. Assembly of an elution kit that comprises a single piece housing may be quick and/or efficient.

The analytical kit may comprise a fluid path being permanently provided between the elution liquid tube and the test element and comprising a fluid path closure element, which is configured to:
stop the liquid from passing from the elution kit to the eluate application zone in a closed state of the fluid path; and
allow the liquid to pass from the elution liquid tube to the eluate application zone in an opened state of the fluid path.

A permanent fluid path, such as a tubing that can fluidically connect the elution liquid tube with the test element in an opened state, is very user friendly, as the user is not required to establish the fluid path by himself/herself. It may only be required to establish an open state for fluidically connecting the elution liquid tube with the test element. This step may be performed once the elution of the biological sample in the liquid has been completed. The open state for fluidically connecting the elution liquid tube with the test element may be established by pulling, rotating and/or pushing the fluid path closure element or a portion thereof. For example, a plug may be pulled. In an alternative embodiment, the swab may be pushed through a membrane. In another alternative embodiment, a valve may be rotated.

The fluid path closure element may comprise: a valve element configured to be mechanically transferred from the opened state into the closed state of the fluid path; a plug which may be pulled and/or a breakable barrier which can have an intact state that corresponds to the closed state or a broken state that corresponds to the opened state.

A rotary fluid path closure element, as, for example, a valve may reversibly open and/or close the fluid path. The same may apply to a fluid path closure element that can be pulled, such as a plug. A breakable barrier, such as a membrane may be configured to only open the fluid path one single time. The breakable barrier may have the advantage that it is a cheap element and/or may be simple to be produced and/or assembled with a housing.

The elution liquid tube and the test element may be or may correspond to separate elements and/or units, optionally wherein the elution liquid tube and the test element can be brought into connection to each other, specifically a fluidic connection to transfer the eluted sample liquid onto the test element.

If the elution liquid tube and the test element are or correspond to separate elements, this may provide a high degree in versatility as the elution liquid tube and the test element may be interchangeably connected, i.e., a specific elution liquid tube may be arbitrarily connected to a test element. Further, the production of such an analytical kit may be simple and/or efficient.

The elution liquid tube and the test element may comprise a coupling mechanism for coupling the elution liquid tube to the test element and specifically being configured to allow a spill-free transfer of the eluted sample liquid onto the eluate application zone of the test element.

A coupling mechanism may support the user in correctly establishing a fluid connection between the elution liquid tube and the test element. The coupling mechanism may comprise a locking mechanism, a threaded mechanism, a hook and/or spring and a recess, a Luer Lock mechanism or the like. The coupling mechanism may guide the user in an attempt to establish a fluid connection between the elution liquid tube and the test element. Further, the coupling mechanism may allow a user to focus on the transfer of the liquid onto the test element while the connection between the elution liquid tube and the test element is secured and the user is not required to permanently hold both elements in order to establish the fluid connection. In a specific embodiment, the transfer of the fluid from the elution liquid tube to the test element is spill-free and small amounts/volumes of liquid can be safely transferred without the risk of losing a portion thereof by spilling and/or evaporation.

At least one element of the analytical kit may be configured for single-use, which may allow providing a relatively eco-friendly analytical kit, specifically in a case when at least some of the elements of the analytical kit are compostable and/or a potentially required cleaning procedure is not eco-friendly. Moreover, single-use components may be provided at low costs and may be simple to handle and to dispose after use.

At least one element of the analytical kit may be configured for multiple/repeated use, which may allow providing an eco-friendly analytical kit, specifically in a case when a potentially required cleaning procedure to clean the at least one element of the analytical kit is also eco-friendly.

According to another aspect, which may be considered the third aspect of the present disclosure, a method of eluting and analyzing a biological sample comprises the steps: providing an analytical kit of any one of the embodiments described herein with the liquid being provided in the interior space of the elution liquid tube; collecting the biological sample with the head portion of the sample collection swab; inserting the sample collection swab into the interior space through the insertion opening with the head portion ahead; pushing the head portion towards the dispense opening into the elution zone at least partially across the at least one elution portion and wetting the head portion of the sample collection swab with the liquid; pulling the sample collection swab inside the elution zone at least partially across the at least one elution portion towards the insertion opening; opening the dispense opening while the sample collection swab remains in one position; pushing the sample collection swab towards the dispense opening to dispense the eluted sample liquid onto the test element; and analyzing the biological sample by reading the result from the test detection zone.

The method may be simple, reliable, safe and/or repeatable. Specifically, all steps may be easily performed by a non-professional user at home. In an alternative embodiment, at least one step of the method may be configured to be performed by a professional health care worker and/or a diagnostic machine/apparatus.

Analyzing a biological sample may comprise detecting whether or not at least one specific predetermined analyte is present in a biological sample, such as, for example, a molecule or a fragment of a molecule, such as an antigen, an antibody, a protein, a DNA strand or another molecule or a respective fragment thereof.

The liquid being provided in the interior space of the elution liquid tube may correspond to a buffer solution, an aqueous solution containing a salt, a detergent, a solubilizing agent, a stabilizer, a solvent and/or a lipid.

Collecting the biological sample with the head portion of the sample collection swab may comprise collecting a sample from a nose or another body part. The biological sample may specifically comprise at least one body fluid, molecules produced by a body and/or an organism on the body and/or cells of a body. This step may specifically be performed manually.

Inserting the sample collection swab into the interior space through the insertion opening with the head portion ahead may comprise sticking the sample collection swab with its longitudinal axis of the stick portion along a longitudinal axis of the interior space. This step may specifically be performed manually. In an alternative embodiment, this step may be performed by a machine/apparatus.

Pushing the head portion towards the dispense opening into the elution zone at least partially across the at least one elution portion and wetting the head portion of the sample collection swab with the liquid may specifically be performed manually. This step may specifically be performed manually. In an alternative embodiment, this step may be performed by a machine/apparatus.

Pulling the sample collection swab inside the elution zone at least partially across the at least one elution portion towards the insertion opening may specifically be performed manually. In an alternative embodiment, this step may be performed by a machine/apparatus.

The pushing and the pulling may be performed a predetermined number of times. The pushing and the pulling may be performed once, twice, three, four, five, six or more times. The more often the pushing and the pulling is performed, the higher is the amount of biological sample being eluted and the more sensitive is the test. To increase the reliability of the test, an exact or a lowest number of times for the pushing and/or the pulling is predetermined. The pushing and/or the pulling may be performed between two specific and/or predetermined positions to which the head portion of the sample collection swab can or must be pushed and/or pulled. These positions may be marked by a mark inside or outside the sample collection tube. Instead of or in addition to a mark, at least one bulge may be provided inside the elution liquid tube. The bulge may provide a visible and a haptic reference for the user such that the user gets a feedback where to stop the sample collection swab while pushing and pulling. This step or these steps may specifically be performed manually. In an alternative embodiment, at least some of the steps may be performed by a machine/apparatus.

The step of opening of the dispense opening while the sample collection swab remains in one position may be preceded by fixing and/or adjusting the position of the sample collection swab. The sample collection swab and the liquid surrounding and/or filling the same may block and/or seal the tube between the insertion opening and the dispense opening for air, such that the liquid inside the elution liquid tube is maintained inside the elution liquid tube and does not “fall out” driven by gravitation when opening the dispense opening and when the sample collection swab remains in a fixed position. This step may specifically be performed manually. In an alternative embodiment, the step may be performed by a machine/apparatus.

The step of opening the dispense opening may be followed by establishing a fluid connection between the dispense opening and the eluate application zone of the test element and/or positioning the dispense opening above the eluate application zone of the test element. The fluid connection between the dispense opening and the eluate application zone may be blocked before the elution is completed to achieve a high degree of elution and therefore a high sensitivity before starting the test. This step may specifically be performed manually. In an alternative embodiment, the step may be performed by a machine/apparatus.

The step of pushing the sample collection swab towards the dispense opening to dispense the eluted sample liquid onto the test element allows ejecting and/or dosing the eluted sample liquid. The pushing may be performed to a specific and/or predetermined position to which the head portion of the sample collection swab can or must be pushed. This position may be marked by a mark inside or outside the sample collection tube, by a mark and/or a bulge and/or a tapered opening that stops the movement of the sample collection swab. This step or these steps may specifically be performed manually. In an alternative embodiment, at least some of the steps may be performed by a machine/apparatus.

Analyzing the biological sample by reading the result from the test detection zone may specifically be performed by a user him-/herself. A negative result, i.e., in most cases the analyte is not present and therefore not detected, may be indicated by the visibility of a control line and the lack of a test line. A positive result, i.e., in most cases the analyte is present and therefore detected, may be indicated by the visibility of a control line and a test line. Alternatively or in addition, a machine and/or sensor may detect and/or read out the result from the test element, specifically a test strip. The test result might, in addition or alternatively, be indicated in a different manner such as, for example, a fluorescence or another type of indication.

In the following, some example embodiments will be described in detail, wherein this disclosure should not be understood to be limited to the example embodiments described. The following examples and figures are provided to aid the understanding of this disclosure, the true scope of which is set forth in the appended claims. Single features being described in a particular embodiment may be arbitrarily combined, given that they are not excluding each other. In addition, different features which are provided together in the example embodiments are not to be considered restrictive to this disclosure. Skilled artisans appreciate that elements in the figures are illustrated for simplicity and clarity and have not necessarily been drawn to scale. For example, the dimensions of some of the elements in the figures may be exaggerated relative to other elements whereas other elements may have been left out or represented in a reduced number in order to enhance clarity and improve understanding of the aspects of the present disclosure. The same reference numerals are used among different embodiments and examples for the same or similar elements or elements that have similar or the same effects.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 is a schematical drawing of an elution kit with an elution liquid tube and a sample collection swab according to an embodiment;

FIG. 2a)-c) are schematical drawings of an elution kit during operation according to an embodiment, illustrating three different states of operation;

FIG. 2d) is an exploded view of a portion of FIG. 2b) as shown;

FIG. 3a)-3f) are schematical drawings of elution kits according to six different embodiments;

FIG. 4a)-4f) are schematical drawings of cross sections of elution portions according to six different embodiments;

FIG. 5a)-5c) are schematical drawings of sample collection swabs according to three different embodiments;

FIGS. 6a) and 6b) are each schematical drawings of elution liquid tubes according to two embodiments;

FIG. 7 is a schematical drawing of an analytical kit comprising a test element and an elution kit with an elution liquid tube and a sample collection swab according to an embodiment;

FIG. 8 is a schematical drawing of an analytical kit comprising a test element and an elution kit with an elution liquid tube and a sample collection swab according to another embodiment;

FIG. 9 is a schematical drawing of an analytical kit comprising a test element and an elution kit with an elution liquid tube and a sample collection swab according to another embodiment; and

FIG. 10 is a flow chart of a method of eluting and analyzing a biological sample.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

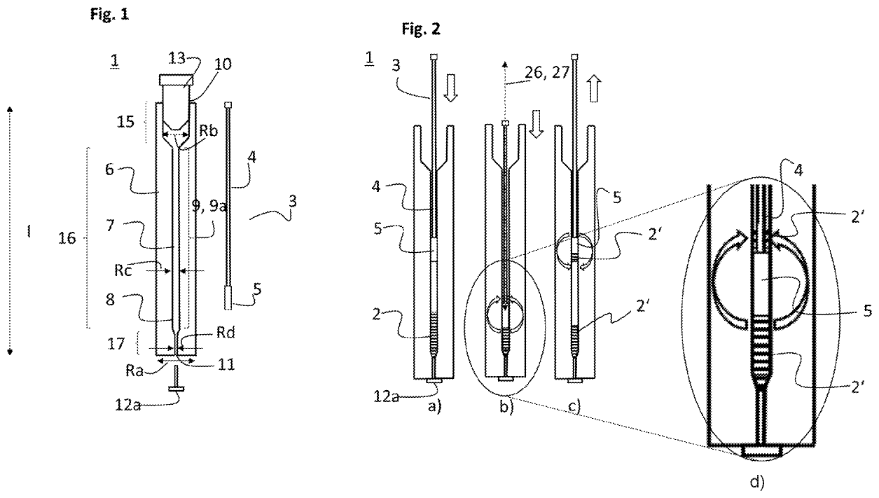

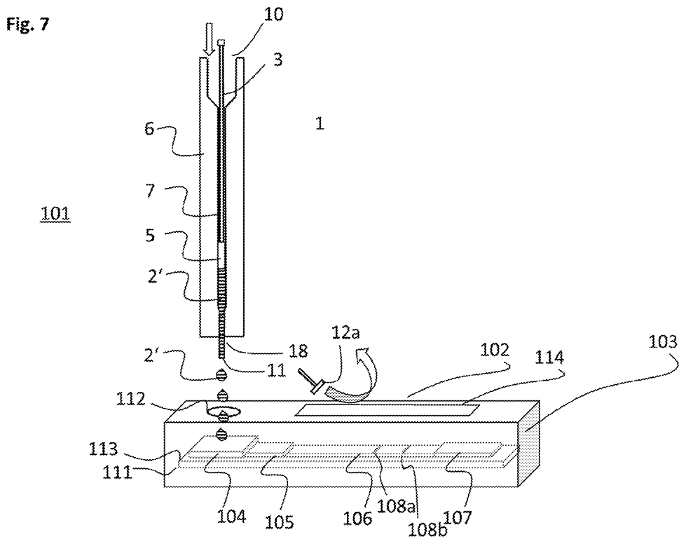

FIG. 1 is a schematic of an elution kit 1 with an elution liquid tube 6 and a sample collection swab 3 according to an embodiment. The elution kit 1 is configured for eluting a biological sample in a liquid 2 (see, for example, FIG. 2) and dispensing the eluted sample liquid 2′ (see, for example, FIG. 2) onto a test element 102 of an analytical kit 101 (see, for example, FIG. 7-9). The elution kit 1 comprises the sample collection swab 3 for collecting the biological sample, wherein the sample collection swab 3 comprises a stick portion 4 for being hand-held and a deformable head portion 5 on the stick portion 4 for collecting the biological sample, wherein the head portion 5 is porous for the liquid 2. On the left side, the elution liquid tube 6 and on the right side, the sample collection swab 3 are shown.

The sample collection swab 3 comprises a lengthy stick portion 4 for being hand held and on one end of the stick portion 4, a head portion 5 is attached. The head portion 5 may be soft to avoid injury of the body parts, which are contacted by the head portion 5 (such as the interior of a nose of a user and/or a patient). Further, the head portion 5 may comprise at least one of the following: a sponge, a sponge-like material, a tissue, wool, cotton, a polymer, fabric, fibers or the like. The head portion may be soft, resilient and/or flexible. The stick portion 4 may comprise at least one of the following: a polymer, a thermoplastic material, a piece of wood, organic material, a metal or the like.

The elution liquid tube 6 comprises an interior space 7 for housing the liquid 2, receiving the sample collection swab 3, specifically along a longitudinal axis 26 of the elution liquid tube 6 and immersing and wetting the head portion 5 in the liquid 2 and thereby eluting the biological sample in the liquid 2. The liquid may, for example, correspond to an aqueous buffer solution. Further, the elution liquid tube 6 comprises an insertion opening 10 on a first side (here upper side) of the interior space 7 for inserting the sample collection swab 3 into the interior space 7 and a dispense opening 11 on a second side (here lower side) of the interior space 7 adjacent the first side for dispensing the eluted sample liquid. The interior space 7 may be substantially channel-like, i.e., a long tube which substantially extends from the insertion opening 10 towards the dispense opening 11 and having a longitudinal axis 26 which may correspond to a common longitudinal axis 26 passing the interior space 7, the dispense opening 11 and the insertion opening 10. The sample collection swab can be received along the common longitudinal axis 26 substantially centered in the interior space 7 such that the common longitudinal axis 26, 27 corresponds and/or aligns with the longitudinal axis 27 of the sample collection swab 3 when being inserted at least partially.

The elution liquid tube 6 may comprise at least one of: a transparent material, a polymer material, a duroplast, glass, metal or the like. A transparent material may comprise a polymer and/or a glass. The elution liquid tube 6 may be substantially rigid and/or stable in shape. The elution liquid tube 6 may alternatively be (slightly) deformable which means, for example, that the elution liquid tube 6 can be pressed together with two fingers for example. If a user applies no force, the elution liquid tube 6 may be stable in shape in all cases.

The elution kit 1 comprises a first closure element 12a (which may correspond to a plug and/or a sealing foil, without limitation) to open and close the dispense opening 11 (on the lower side) and a second closure element 13 to open and close the insertion opening 10 (on the upper side). The second closure element 13 is shown to be almost in its position to completely close the insertion opening 10. The second closure element 13 is indicated to be a plug 13 with an upper disk that is slightly larger in circumference than the central portion of the plug 13. The plug 13 is configured to be plugged into an insertion zone 15 of the elution liquid tube 6. Further, the second closure element 13 is shown to have a tapered lower end that fits a tapered portion indicated on the insertion zone 15 of the elution liquid tube 6. The second closure element 13 is shown to be inserted partially into the interior space 7 in the insertion zone 15. The first closure element 12a corresponds to a plug that is configured to be inserted into the interior space 7 in the dispense zone 17. In the shown scheme of present FIG. 1, the first closure element 12a is not yet inserted into the interior space 7 and therefore, the dispense opening 11 is in an opened state.

In the present embodiment, the first closure element 12a and the second closure element 13 correspond to a plug. Alternatively, at least one of the closure elements 12a, 13 may comprise at least one of the following: a film, a sheet, a foil, a membrane, a plate, a cap.

The insertion zone 15 which is tapered in this embodiment allows guiding the sample collection swab 3 into the interior space 7 in an elution zone 16 having a smaller diameter than the interior space 7 in the insertion zone 15. This allows to easily insert the sample collection swab 3 into the tight interior space 7 in the elution zone 16 while providing a relatively large insertion opening 10. By providing a tapered structure, the sample collection swab 3 may easily slide into the interior space 7 with the reduced diameter. The lowest portion (i.e., the portion furthest away from the insertion opening 10) of the interior space 7 in the elution zone 16 is also tapered in this embodiment to smoothly further reduce the diameter of the interior space 7 towards the interior space 7 of the dispense zone 17 which ends with the dispense opening 11. The dispense opening 11 and the insertion opening 10 are opposite/adjacent each other and fluidically connected by the interior space 7. In this embodiment, the diameter of the interior space 7 in the insertion zone 15 is larger than diameter of the interior space 7 in the elution zone 16 and the diameter of the interior space 7 in the elution zone 16 is larger than the diameter of the interior space 7 in the dispense zone 17. In the dispense zone 17 of this embodiment, the interior space 7 has a diameter that may be configured to stop the sample collection swab 3 from reaching through. The tapered lower portion of the interior space 7 in the elution zone 16 may smoothly stop the sample collection swab 3 from reaching through the lower channel portion. The head portion 5 may be rested on the tapered portion.

The interior space 7 is defined by an inner surface 8 which leaves/surrounds a gap that may be considered a channel and that comprises an elution zone 16 with at least one elution portion 9, 9a having a smallest side-to-side distance y ranging between approximately 70% and 140% of a largest side-to-side distance x of the head portion 5 of the sample collection swab 3. The inner surface 8 defines a gap 14 through which the sample collection swab 3 can be pushed and pulled in a closed state of the dispense opening 11, at least in the elution zone 16 and the insertion zone 15.

In the embodiment of FIG. 1, the elution portion 9 has a smallest side-to-side distance y (diameter here) ranging between approximately 95% and 105% of a largest side-to-side distance x (diameter here) of the head portion 5 of the sample collection swab 3.

In the embodiment of FIG. 1, the elution portion 9, 9a is indicated as substantially being homogenous over the entire elution zone 16. The elution portion 9, 9a comprises an elution region with a length ranging between approximately 10% and 98% of the length of the elution liquid tube. In the specific embodiment, the length of the elution region ranges approximately between 75% and 85% of the length of the elution liquid tube 6.

The elution liquid tube 6 may be round on the outside and/or round on the inside. Specifically, the cross section of the interior space 7 and more specifically the gap 14 defined by the elution portion 9, 9a (in the cross section) may be round in this embodiment. Therefore, the smallest side-to-side distance y of the elution portion 9, 9a may correspond to a diameter. The same applies to the head portion 5 of the sample collection swap 3, which may be round in its cross section and therefore the largest side-to-side distance x of the head portion 5 may correspond to its diameter (on the widest position along a horizontal axis which is perpendicular to the length axis of the stick portion).

FIG. 2a)-c) are schemes of an elution kit 1 during operation according to the embodiment of FIG. 1, wherein FIG. 2a)-2c) correspond to three different states of operation and a detailed view of FIG. 2b) is shown in FIG. 2d). The elution liquid tube 6 has a closed dispense opening 11 and an opened insertion opening 10. In other words, the dispense opening 11 is closed by means of the first closure element 12a and the insertion opening is in an opened state as the second closure element 13 is removed. The first closure element 12a is inserted into the interior space 7 and reaches therein substantially to block the full length of the dispense zone 17.

In FIG. 2a), the sample collection swab 3 is inserted into the interior space 7 with the head portion 5 reaching half way down into the elution zone 16. The sample collection swab 3 is in the situation to be pushed downwards (indicated by the arrow on the top), towards the dispense opening 11. The head portion 5 has more less the same diameter as the elution portion, which is a region in which the interior space 7 has a reduced diameter compared to the insertion portion. In FIG. 2a), the sample collection swab 3 is in a position in which it does not yet reach the liquid 2 and is therefore still dry. It may be the case, that the head portion is somewhat squeezed into the interior space 7 in the elution zone 16, specifically when the diameter of the head portion 5 exceeds (on the widest position along a horizontal axis which is perpendicular to the length axis of the stick portion) the diameter of the interior space 7 in the elution zone 16.

In FIG. 2b), the sample collection swab 3 is inserted into the interior space 7 with the head portion 5 reaching further down into the elution zone 16 as compared to the situation in FIG. 2a) (indicated by the arrow on the top). The head portion 5 in fact reaches the liquid in the lower portion of the elution zone 16. As can be seen in the extended view of FIG. 2b), the head portion 5 is immersed in the liquid 2 and a portion of the liquid 2 passes and/or bypasses the head portion 5 upwards (indicated by bent arrows) and another portion is sucked into the pores of the head portion 5. By (by)passing the head portion 5, the liquid 2 contacts the biological sample. The biological sample becomes eluted in the liquid 2 and the liquid 2 then corresponds to an eluted sample liquid 2′, i.e., a liquid that contains at least some of the sample which was previously sticking on the sample collection swab 3.

In FIG. 2c), the sample collection swab 3 is pulled up again (indicated by the arrow on the top) towards the insert opening 10. The at least partially eluted sample liquid 2′ (by)passes the head portion 5 downwards towards the dispense opening 11 (indicated by bent arrows).

Every time, the sample collection swab 3 is pushed or pulled, the liquid 2 or eluted sample liquid 2′ bypasses and/or passes the head portion 5 and the biological sample becomes more and more eluted and therefore, pushing and pulling the sample collection swab 3 through the liquid 2 multiple times increases the amount of the biological sample eluted in the liquid 2 such that the eluted sample liquid 2′ becomes more concentrated which has the effect that the test becomes more sensitive due to an increased concentration of sample in the liquid 2.

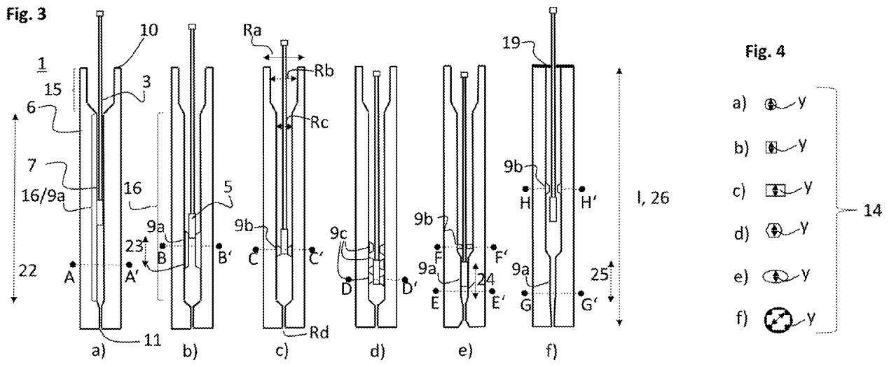

FIG. 3a)-3f) are schemes of elution kits according to six different embodiments. In FIG. 3a), the elution kit according to FIGS. 1 and 2 is shown. The elution portion 9, 9a comprises an elution region with a length 22 ranging between approximately 10% and 98%, in the present case between approximately 75% and 90% of the length of the elution liquid tube 6 and 100% of the length of the elution zone 16. In other words, the elution portion 9, 9a substantially ranges over the entire length of the elution zone 16. The cross section of the elution portion 9, 9a (or any other portion of the elution liquid tube 6), as, for example, indicated by the line A-A′ may correspond to any one of the shapes shown in FIG. 4a)-f), which is described further below. The main function of the elution portion 9, 9a according to this embodiment may be the bypassing and/or passing of the head portion 5 by the liquid when pushing and pulling the sample collection swab 3. The narrow pipe-/channel-like volume of the interior space 7 allows the treatment of minor amounts of liquids. The tapered portion in the insertion zone 15 assists the user by centering the sample collection swap and finding the pipe-/channel-like volume of the interior space 7. The head portion 5 of the sample collection swab 5 may slide along the sidewalls at the tapered portion into the interior space 7 in the elution zone 16. It may require a pushing force to move the head portion 5 downwards.

In FIG. 3b), the elution kit 1 according to another embodiment is shown. The elution liquid tube 6 has a tapered elution portion 9, 9a that comprises an elution region with a length 23 ranging between approximately 10% and 98%, in the present case of approximately 10-13% of the length of the elution liquid tube 6. The elution portion 9, 9a is positioned in the lower half, specifically in the lower third of the elution zone 16 and the elution liquid tube 6. The remaining portion of the interior space 7 in the elution zone 16 is broader in diameter than the elution portion 9, 9a. The function of the elution portion 9a according to this embodiment may be the bypassing and/or passing of the head portion 5 by the liquid when pushing and pulling the sample collection swab 3 and the wiping off of some of the biological sample and/or the liquid trapped/soaked in the head portion 5 of the sample collection swab 3. In the regions above and/or below the elution portion 9a, the liquid may soak into the head portion 5 and when passing the elution portion 9a, at least some of the liquid soaked in the head portion 5 may be wiped off. Further, also the biological sample trapped on and/or in the head portion 5 of the sample collection swab 3 may be wiped off such that the biological sample may easily be eluted in the liquid.

For simplicity, none of the before mentioned closure elements and no liquid is shown in the drawings. The cross section of the elution portion 9, 9a, as, for example, indicated by the line B-B′ may correspond to any one of the shapes shown in FIG. 4a)-f) which is described further below.

In FIG. 3c), the elution kit 1 according to another embodiment is shown. The elution liquid tube 6 has a tapered elution portion 9, 9b that corresponds to an elution bulge 9b. The elution bulge 9b is positioned in the lower third of the elution zone 16 and elution liquid tube 6. The elution bulge 9b may in the present case be shorter in length than approximately 10% of the length l of the elution liquid tube 6, for example, approximately 0.5-5% of the length l of the elution liquid tube 6. The remaining portion of the elution zone 16 is broader in diameter than the elution portion 9b and may in some cases at least partially correspond to an elution region as described for FIG. 4a). The main function of the elution portion 9b according to this embodiment may be the wiping off of some of the liquid trapped/soaked in the head portion 5 of the sample collection swab 3. Further, also the bypassing and/or passing of the head portion 5 by the liquid when pushing and pulling the sample collection swab 3 may be a function. The cross section of the elution portion 9b, as, for example, indicated by the line C-C′ may correspond to any one of the shapes shown in FIG. 4a)-f) which is described further below.

In FIG. 3d), the elution kit 1 according to another embodiment is shown. The elution liquid tube 6 has an elution portion 9, 9c that corresponds to a helical thread-like bulge 9c. The helical thread-like bulge 9c is positioned in the lower third of the elution zone 16 and elution liquid tube 6. The remaining portion of the elution zone 16 is broader in diameter than the elution portion 9, 9c and may in some cases at least partially correspond to an elution region as described for FIG. 4a). The helical thread-like bulge 9c may have the function of mixing the liquid specifically along and/or the thread-like ridges and/or depressions. Further, the helical thread-like bulge 9c may have the function of efficiently wiping off at least a portion of the biological sample and/or the soaked liquid in the head portion 5. In more detail, pushing the head portion 5 through the helical thread-like bulge 9c may squeeze and/or press the head portion 5 multiple times and therefore, efficiently wipe off substances trapped in and/or on the head portion 5. The cross section of the elution portion 9, 9c, as, for example, indicated by the line DD′ may correspond to any one of the shapes shown in FIG. 4a)-f) which is described further below.

In FIG. 3e), the elution kit 1 according to another embodiment is shown. The elution liquid tube 6 has two elution portions 9, 9a, 9b, respectively corresponding to an elution bulge 9b and an elution region 9a with a length 24 ranging between approximately 10% and 98%, in the present case between approximately 10-13% of the length of the elution liquid tube 6. The elution portions 9a, 9b are positioned in the lower third of the elution zone 16 and elution liquid tube 6. The remaining portion of the elution zone 16 is broader in diameter than the elution portion 9a, 9b and may in some cases at least partially correspond to an elution region as described for FIG. 4a). The cross section of the elution portions 9a, 9b, as, for example, respectively indicated by the lines F-F′ and E-E′ may correspond to any one of the shapes shown in FIG. 4a)-f) which is described further below. The elution bulge 9b is provided above the elution region 9a and has a very short length, for example, approximately 0.5% of the length l of the elution liquid tube 6. The elution bulge 9b may provide the main function of a wiping off of the liquid from the head portion 5 while the elution region 9a may provide the main function of a mixing by passing and/or bypassing the head portion 5 of the liquid. This may have a synergy effect of both elution portions 9a, 9b leading to an improved elution of the biological sample. In this embodiment, the dispense opening 11 is tapered in its diameter from the outside towards the inside, i.e., upwards. This may, for example, allow a dispense tip, an extension of a plug and/or cap to be easily inserted into the dispense opening 11.

In FIG. 3f), the elution kit 1 according to another embodiment is shown. The elution liquid tube 6 has two elution portions 9, 9a, 9b, respectively corresponding to an elution bulge 9b and an elution region 9a with a length 25 ranging between approximately 10% and 98%, specifically between approximately 10-15% of the length l of the elution liquid tube 6. The elution portions 9a, 9b are substantially positioned in the lower half of the elution zone 16 of the elution liquid tube 6. The remaining portion of the elution zone 16 is broader in diameter than the elution portion 9, 9b and may in some cases at least partially correspond to an elution region as described for FIG. 4a). The elution bulge 9b is positioned in the middle or slightly below the middle position of the elution liquid tube 6 with respect to the length axis. This may allow to prevent the liquid from spilling upwards towards the insertion opening. A further element for preventing a spilling of liquid out of the elution liquid tube 6 is provided in a membrane and/or splash guard 19 that leaves only a small gap for inserting the sample collection swab 3. The membrane 19 may therefore be resilient and/or flexible. In an alternative embodiment, instead of a membrane 19, a plate, a sheet and/or another element having a small gap which allows inserting the sample collection swab 3 may be provided.

The cross section of the elution portions 9a, 9b, as, for example, respectively indicated by the lines H-H′ and G-G′ may correspond to any one of the shapes shown in FIG. 4a)-f) which is described further below.

A further function of all or at least some described elution portions 9, 9a, 9b, 9c may be a protection from upwards spilling of the liquid. Moreover, the function of all or at least some described elution portions 9, 9a, 9b, 9c may correspond to a stopping and/or slowing down of the sample collection swab 3 due to an increased mechanical resistance when passing the head portion 5. Moreover, a function of all or at least some described elution portions 9, 9a, 9b, 9c may relate to the possibility of resting of the sample collection swab 3 in a certain position due to increased mechanical resistance. In that case, the user may leave the head portion 5 in the position of the according elution portion 9, 9a, 9b, 9c and the sample collection swab rests there and does not slide down driven by gravity even when the user does not hold the sample collection swab 3. If the head portion 5 is immersed in the liquid in that position, the passage between the insertion opening 10 and dispense opening 11 is blocked and the liquid does not leave the interior space 7 of the elution liquid tube 6 when the dispense opening 11 is in an opened state. At least some of the described elution portions 9a, 9b, 9c (FIG. 3b)-f)) are indicated to be tapered on their upper and lower sides such that the head portion 5 is smoothly guided towards the gap 14 defined by the according elution portions 9a, 9b, 9c when pushing and pulling the sample collection swab 3. Further, the head portion 5 is prevented from damage by smoothly guiding it along the tapered surfaces as sharp edges which might harm the head portion 5 can be avoided.

The elution portions 9, 9a, 9b, 9c shown in the embodiments of all figures may be arbitrarily combined if structurally possible and not contradictory.

FIG. 4a)-4f) are schemes of cross sections of elution portions according to six different embodiments, without limitation. The cross sections correspond to the gaps 14, which are defined by the respective elution portion 9, 9a, 9b, 9c. In FIG. 4a), the shape of the gap 14 corresponds to a circular shape and the smallest side-to-side distance y of elution portion corresponds to the diameter of the circular shape. In FIG. 4b), the shape of the gap 14 corresponds to a square shape and the smallest side-to-side distance y of elution portion corresponds to the distance between two parallel sides of the square shape. In FIG. 4c), the shape of the gap 14 corresponds to a rectangular non-square shape and the smallest side-to-side distance y of elution portion corresponds to the distance between two longer parallel sides of the rectangular shape. In FIG. 4d), the shape of the gap 14 corresponds to a hexagonal shape and the smallest side-to-side distance y of elution portion corresponds to the distance between two parallel sides of the hexagonal shape. In FIG. 4e), the shape of the gap 14 corresponds to an elliptic shape and the smallest side-to-side distance y of elution portion corresponds to the shortest distance between two sides of the elliptic shape. In FIG. 4f), the shape of the gap 14 corresponds to a cross shape in a circular support of the elution portion 9, 9a, 9b, 9c and the smallest side-to-side distance y of elution portion corresponds to the shortest distance between two edges of the cross shape. The edges may be rounded to avoid damage to the head portion 5. The examples given herein for the gaps 14 are not limiting the possibilities of choice of a shape. Further, the examples given herein may also apply to the cross section of the interior space 7, i.e., a gap in another zone such as the insertion zone 15, the elution zone 16 where no elution portion is provided and/or the dispersion zone 17.

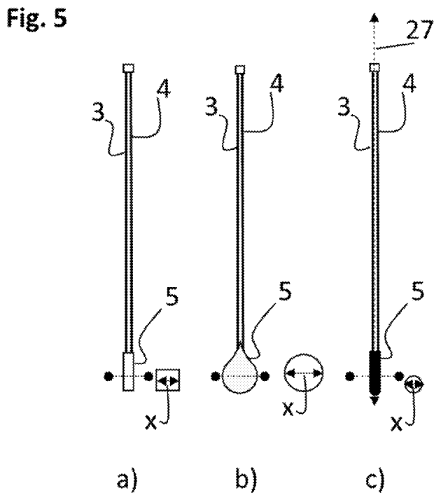

FIG. 5a)-5c) are schemes of sample collection swabs 3 according to three different embodiments. In FIG. 5a), the head portion 5 has a rectangular shape in its cross section (indicated by the dashed cut line) as indicated by the drawing to the right of the sample collection swap 3 in FIG. 5a). The head portion also has a rectangular shape along the longitudinal axis 27. In FIG. 5b), the head portion 5 has a substantially drop-like shape along its longitudinal axis 27 and a round shape in its cross section (indicated by the dashed cut line) as indicated by the drawing to the right of the sample collection swap 3 in FIG. 5b). The largest side-to-side distance of the head portion x corresponds in this embodiment to the diameter of the head portion 5 on the widest position along a horizontal axis which is perpendicular to the length/longitudinal axis 27 of the stick portion 4. In FIG. 5c), the head portion 5 has a long extended shape and a rounded tip on its end along its longitudinal axis 27 and a round shape in its cross section (indicated by the dashed cut line) as indicated by the drawing to the right of the sample collection swap 3 in FIG. 5c). A rounded and or round shape of the head portion 5 can be inserted into a gap and/or a body hole smoothly and injuries of a patient can be prevented due to a smooth and/or soft surface. In general, the largest side-to-side distance x of the head portion 5 may be measured at the widest position of the head portion 5. It may correspond to a diameter of a round shape (see FIG. 5b) and FIG. 5c)) or a distance between two parallel sides (at the largest distance of two surfaces) (see FIG. 5a)). The examples given herein for the shapes of the head portion 5 are not limiting the possibilities of choice shapes.

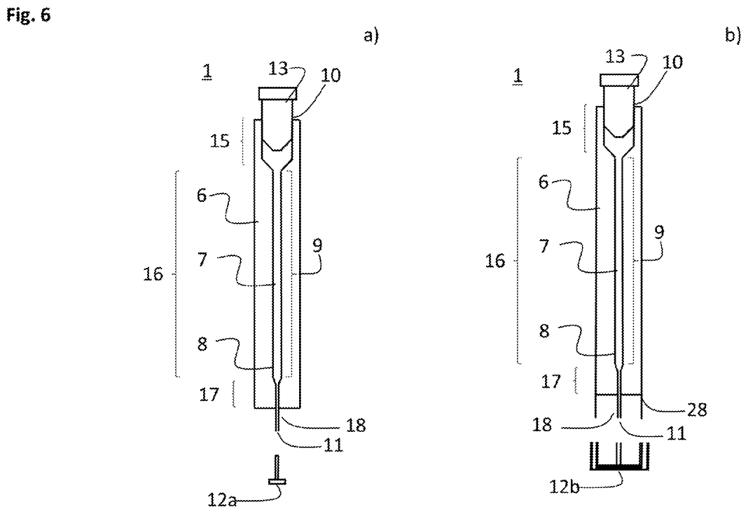

FIGS. 6a) and 6b) are schemes of elution liquid tubes 6 according to two embodiments. In FIG. 6a), a dispense nozzle 18 in the form of an extended tip is provided on the dispense opening 11 to precisely apply the eluted sample liquid onto a target such as a field of a test element. The dispense nozzle 18 may be permanently provided on the elution liquid tube 6 or may be coupled thereon and decoupled therefrom. The dispense opening 11 may be closed by means of a plug 12a. Similarly as in FIG. 6a), also in FIG. 6b), a dispense nozzle 18 in the form of an extended tip is provided on the dispense opening 11. Further, on the outer circumference a rim 28 is provided which allows a user to stand the elution liquid tube 6 upright on a plane surface. The rim 28 is longer than the dispense nozzle 18. The dispense opening 11 may be closed by means of a cap 12b. In this embodiment of the cap 12b, the dispense nozzle 18 is received by an extended portion in the center of the cap 12b which has a recess/hole. The cap 12b may instead have an extended portion in the center of the cap 12b which is configured to be inserted into the dispense opening 11. On the sides of the cap 12b, a circular receiving recess is provided for receiving the rim 28 and securing the cap 12b on the elution liquid tube 6. The cap 12b may be realized according to an alternative structure. The cap 12b and/or the plug 12a may be secured on the elution liquid tube 6, for example, by a band and/or a wire.

FIG. 7 is a scheme of an analytical kit 101 comprising a test element 102 and an elution kit 1 with an elution liquid tube 6 and a sample collection swab 3 according to an embodiment. The elution kit 1 may be an elution kit 1 according to any one described herein. The situation that is described in this figure is a situation in which the sample was already eluted in the liquid 2, the plug 12a is removed and the sample collection swab 3 is pushed downwards as indicated by the arrow above to dispense and/or eject the eluted sample liquid 2'. The droplets which are ejected by means of the dispense nozzle 18 of the elution liquid tube 6 are indicated to be transferred through a sample application recess 112 of a test element housing 103 of the test element 102 onto an LFA-core strip 111 housed therein. The LFA-core strip 111 comprises a substrate 113 (or backing card), a zone with an eluate application function 104 corresponding to a sample pad onto which the eluted sample liquid 2′ can be applied, a zone with test reaction function 105 which corresponds to a conjugate release pad, a zone with the test detection function 106 which corresponds to a membrane, such as a nitrocellulose pad, and a zone with sample collection function 107 which corresponds to an adsorbent pad. On the membrane, a test line 108a and a control line 108b are provided to make the test result visible for a user who can see through the recess in housing 103 for reading the test result from the LFA-core strip 111.

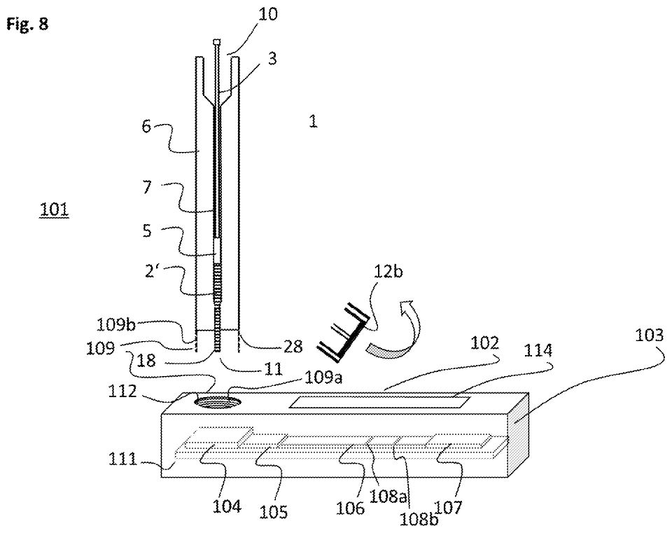

FIG. 8 is a scheme of an analytical kit 101 comprising a test element 102 and an elution kit 1 with an elution liquid tube 6 and a sample collection swab 3 according to another embodiment. The analytical kit 101 of FIG. 8 may however differ from that of FIG. 7 in that a cap 12b is used instead of a plug 12a and the elution liquid tube comprises a rim 28 and a coupling mechanism 109 with two components/elements 109a, 109b for coupling the elution liquid tube 6 to the housing 103 of the test element 102. The coupling mechanism 109, which is shown in this embodiment, relies on a thread 109a in the sample application recess 112 of the housing 103 and a counter element 109b of the thread on the rim 28 of the elution liquid tube 6. The coupling mechanism 109 allows coupling and decoupling the elution liquid tube 6 with the housing 103 such that an eluted sample liquid may be safely and/or spill-free transferred onto the test element 102.

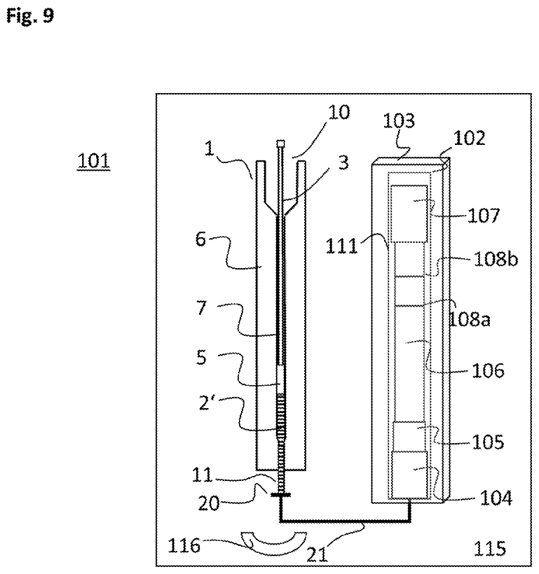

FIG. 9 is a scheme of an analytical kit 101 comprising a test element 103 and an elution kit 1 with an elution liquid tube 6 and a sample collection swab 3 according to another embodiment. The elution liquid tube 6 and the test element 103 are in a fixed relationship with each other. Specifically, the elution liquid tube 6 and the test element 103 may be provided in a common housing 115 and/or on a common support 115. If the elution liquid tube 6 and the test element 103 are provided in a common housing 115, a liquid that might leak out of the elution liquid tube 6 may be collected in a trough 116 and/or a portion of the housing 115 that acts like a trough. In an embodiment, in which a housing 115 is provided, a high degree in stability can be achieved. In an embodiment, in which a common support 115 is provided, a cheap and/or simple production of the analytical kit 109 may be achieved.

The elution liquid tube 6 and the test element 103 are also connected via a fluid path 21 that is in the closed state before the test is started and before the biological sample is eluted in the liquid. When the biological sample is eluted in the liquid, a fluid path closure element 20 such as a membrane and/or a plug may be broken and/or removed to establish a fluidic connection between the elution liquid tube 6 and the test element 103, specifically the sample pad 104 of the test element 103.

In general, the test element/test strip, which can be used together with this disclosure or any embodiment thereof, may differ from the shown test element. For example, the test strip may not have a substrate or may only have a membrane and a sample collection pad but no sample and conjugate pads if the reaction is performed outside of the test strip for example.

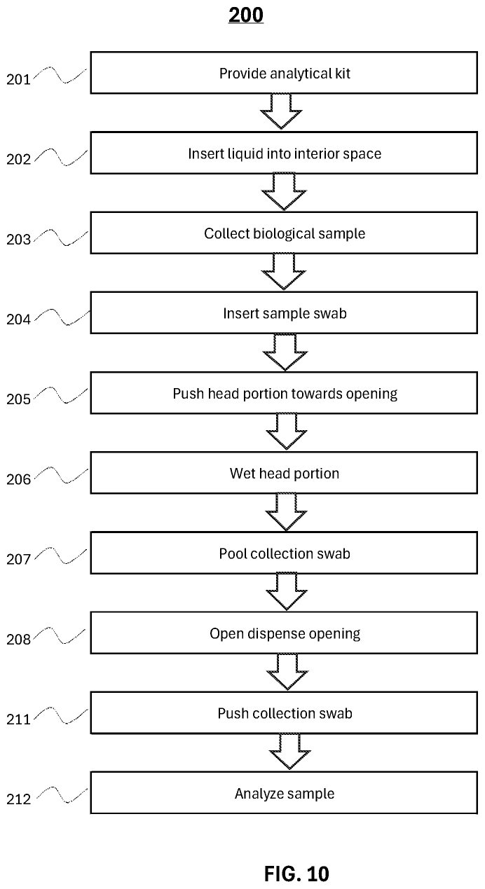

FIG. 10 is a flow chart of a method 200 of eluting and analyzing a biological sample. The method 200 of eluting and analyzing the biological sample comprises the steps:
a. providing 201 an analytical kit as described herein as one of the embodiments wherein the liquid is inserted 202 by the user into the interior space 7 or the liquid is already provided in the interior space 7 of the elution liquid tube 6;
b. collecting 203 the biological sample with the head portion 5 of the sample collection swab 3;
c. inserting 204 the sample collection swab 3 into the interior space 7 through the insertion opening 10 with the head portion 5 ahead;
d. pushing 205 the head portion 5 towards the dispense opening 11 into the elution zone 16 at least partially across the at least one elution portion 9 and wetting 206 the head portion 5 of the sample collection swab 3 with the liquid 2;
e. pulling 207 the sample collection swab 3 inside the elution zone 16 at least partially across the at least one elution portion 9 towards the insertion opening 10;
f. opening 208 the dispense opening 11 while the sample collection swab 3 remains in one position and/or rests in one position;
g. pushing 211 the sample collection swab 3 towards the dispense opening 11 to dispense the eluted sample liquid onto the test element 102; and
h. analyzing 212 the biological sample by reading the result from the test detection zone 106.

Steps d. and e. which refer to the steps of pushing and pulling can be repeated a predetermined number of times, for example, 3, 5, 6, 7, 8 or more times. A specific predetermined number of times for pushing and pulling may ensure that a critical and/or a minimum amount of the biological sample becomes eluted in the liquid leading to a reversible and/or a reliable result and reducing the risk to obtain a false negative.

Modifications and variations of the disclosed aspects are also certainly possible in light of the above description. It is therefore to be understood, that within the scope of the appended claims, this disclosure may be practiced otherwise than as specifically devised in the above examples.

Particularly, it is to be understood that at least some of the drawings or parts are only schematic and provided as way of example only. Also the relationship between elements may be other than the one shown, whereas parts not relevant for the purpose of this disclosure have been omitted.

Also, reference throughout the preceding specification to “one aspect,” “an aspect,” “one example” or “an example,” “one embodiment” or “an embodiment” means that a particular feature, structure or characteristic described in connection with the aspect or example or embodiment is included in at least one aspect, example or embodiment. Thus, appearances of the phrases “in one aspect,” “in one aspect,” “one example” or “an example,” “one embodiment” or “an embodiment,” in various places throughout this specification are not necessarily all referring to the same aspect or example or embodiment.

Furthermore, the particular features, structures, or characteristics may be combined in any suitable combinations and/or sub-combinations in one or more aspects or examples or embodiments.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE NUMERALS

1 elution kit
2 liquid
2′ eluted sample liquid
3 sample collection swab
4 stick portion
5 head portion
6 elution liquid tube
7 interior space
8 inner surface
9 elution portion
9a elution region with a length ranging between 10% and 98% of the length of the elution liquid tube
9b elution bulge
9c helical thread-like bulge
10 insertion opening
11 dispense opening
12a first closure element realized as a plug
12b first closure element realized as a cap
13 second closure element
14 gap defined by elution portion
15 insertion zone
16 elution zone
17 dispense zone
18 dispense nozzle
19 membrane for preventing spilling
20 fluid path closure element
21 fluid path
22, 23, 24, length of elution region ranging between 10% and 98% of the length of the
25 elution liquid tube
26 longitudinal axis of elution liquid tube
27 longitudinal axis of sample collection swab
28 rim
101 analytical kit
102 test element
103 test element housing
104 zone with eluate application function
105 zone with test reaction function
106 zone with test detection function
107 zone with sample collection function
108a test line
108b control line
109 coupling mechanism
109a one element of the coupling mechanism
109b counter element of the coupling mechanism
110 (counter) element of the coupling mechanism
111 LFA-core strip
112 sample application recess
113 substrate
114 recess in housing for reading the test result
115 common housing and/or support structure
116 trough for collecting a leaking liquid
200 method of eluting and analyzing a biological sample
201 providing an analytical kit
202 inserting the liquid into the interior space
203 collecting the biological sample
204 inserting the sample collection swab
205 pushing the head portion towards the dispense opening
206 wetting the head portion
207 pulling the sample collection swab
208 opening the dispense opening
211 pushing the sample collection swab
212 analyzing the biological sample
A-A′ cross section line
B-B′ cross section line
C-C′ cross section line
D-D′ cross section line
E-E′ cross section line
F-F′ cross section line
G-G′ cross section line
H-H′ cross section line
l outer length of the elution liquid tube
Ra outer diameter of the elution liquid tube
Rb largest diameter of the interior space in the insertion portion
Rc largest diameter of the interior space in the elution portion
Rd largest diameter of the interior space in the dispense portion
x largest side-to-side distance of the head portion
y smallest side-to-side distance y of elution portion

What is claimed is:

1. An elution kit for eluting a biological sample in a liquid and dispensing the eluted sample liquid onto a test element of an analytical kit, the elution kit comprising:
a sample collection swab configured for collecting the biological sample, wherein the sample collection swab comprises a stick portion configured for being hand-held and a deformable head portion on the stick portion configured for collecting the biological sample, wherein the head portion is porous for the liquid; and
an elution liquid tube, comprising:
an interior space configured for housing the liquid, receiving the sample collection swab and eluting the biological sample in the liquid,
an insertion opening on a first side of the interior space configured for inserting the sample collection swab into the interior space,
a dispense opening on a second side of the interior space adjacent the first side and configured for dispensing the eluted sample liquid,
a first closure element configured to seal the dispense opening in a water-vapor impermeable manner,
a second closure element configured to seal the insertion opening in a water-vapor impermeable manner, wherein the first closure element and/or the second closure element comprises a foil, and
the liquid, wherein the elution liquid tube contains the liquid,
wherein the interior space is defined by an inner surface that comprises an elution zone with at least one elution portion having a smallest side-to-side distance y ranging between approximately 70% and 140% of a largest side-to-side distance x of the head portion of the sample collection swab and defining a gap through which the sample collection swab can be pushed and pulled in a closed state of the dispense opening.

2. The elution kit according to claim 1, wherein:
the volume of the interior space of the elution liquid tube is dimensioned to house a liquid volume selected from the group consisting of less than 1 ml, less than 500 μl and less than 10 μl;
the ratio “volume of the interior space” “liquid volume” is less than 10; and/or
the ratio “liquid volume” “liquid volume soaked in by the wetted head portion” is between 1 and 10.

3. The elution kit according to claim 1, wherein the elution portion comprises at least one of the following:
at least one elution region with a length ranging between 10% and 98% of the length of the elution liquid tube;
at least one elution bulge with a length that corresponds to less than 10% of the length of the elution liquid tube; and/or
at least one helical thread-like bulge.

4. The elution kit according to claim 1, wherein the elution liquid tube comprises on the side of the dispense opening:
a dispense nozzle defining the dispense opening; and/or
a rim configured for setting down the elution liquid tube in an upright orientation, optionally wherein the rim comprises an element of a coupling mechanism for coupling the elution liquid tube to a test element, optionally wherein the coupling mechanism comprises a thread mechanism, a bayonet and/or a Luer lock mechanism.

5. The elution kit according to claim 1, wherein the interior space comprises:
an insertion zone;
the elution zone; and
a dispense zone, optionally wherein the largest diameter of the interior space in the insertion zone is larger than the largest diameter of the interior space in the elution zone and/or the largest diameter of the interior space in the elution zone is larger than the largest diameter of the interior space in the dispense zone.

6. The elution kit according to claim 1, wherein the outer diameter of the elution liquid tube is selected from the group consisting of 3 or more, 8 or more, and 20 or more times larger than the side-to-side distance y of the elution portion of the interior space.

7. An analytical kit for analyzing a biological sample, comprising:
the elution kit according to claim 1; and
the test element comprising at least an application function, a test reaction function and a test detection function.

8. The analytical kit according to claim 7, wherein the test element comprises a test element housing and/or an LFA-core strip.

9. The analytical kit according to claim 7, wherein:
the elution liquid tube of the elution kit and the test element are fixedly attached to each other and/or supported by or housed in a single unit, and are supported commonly and at least partially by one cardboard; and/or
the analytical kit comprises a fluid path being permanently provided between the elution liquid tube and the test element and comprising a fluid path closure element configured to stop the liquid from passing from the elution kit to an eluate application zone in a closed state of the fluid path and to allow the liquid to pass from the elution liquid tube to the eluate application zone in an opened state of the fluid path.

10. The analytical kit according to claim 9, wherein the fluid path closure element comprises:
a valve configured to be mechanically transferred from the opened state into the closed state of the fluid path; and/or
a breakable barrier which can have an intact state that corresponds to the closed state or a broken state that corresponds to the opened state.

11. The analytical kit according to claim 7, wherein the elution liquid tube and the test element are separate elements, optionally wherein the elution liquid tube and the test element can be brought into a fluidic connection to each other to transfer the eluted sample liquid onto the test element.

12. The analytical kit according to claim 11, wherein the elution liquid tube and the test element comprise a coupler for coupling the elution liquid tube to the test element and configured to allow a spill-free transfer of the eluted sample liquid onto the eluate application zone of the test element.

13. A method of eluting and analyzing a biological sample, comprising:
providing an analytical kit according to claim 7 with the liquid being provided in the interior space of the elution liquid tube;
collecting the biological sample with the head portion of the sample collection swab;
inserting the sample collection swab into the interior space through the insertion opening with the head portion ahead;
pushing the head portion towards the dispense opening into the elution zone at least partially across the at least one elution portion and wetting the head portion of the sample collection swab with the liquid;
pulling the sample collection swab inside the elution zone at least partially across the at least one elution portion towards the insertion opening;
opening the dispense opening while the sample collection swab remains in one position;
pushing the sample collection swab towards the dispense opening to dispense the eluted sample liquid onto the test element; and
analyzing the biological sample by reading the result from a test detection zone.
